(19) United States
(12) Patent Application Publication
(10) Pub. No.: US 2011/0130938 A1
(43) Pub. Date: Jun. 2, 2011

(54) FUEL INJECTING CONTROL METHOD DURING COASTING OF VEHICLE

(75) Inventors: Kil Hyeon Seok, Seoul (KR); Seunghee Han, Hwaseong-si (KR); Kwang Rak Lee, Seoul (KR); Soojin Kim, Suwon-si (KR); Tae Seong Lee, Suwon-city (KR)

(73) Assignees: Hyundai Motor Company, Seoul (KR); Kia Motors Corporation, Seoul (KR)

(21) Appl. No.: 12/836,119

(22) Filed: Jul. 14, 2010

(30) Foreign Application Priority Data
Nov. 27, 2009 (KR) 10-2009-0116097

(51) Int. Cl. B60W 10/06; B60W 10/18; F02D 41/30

(52) U.S. Cl. 701/93; 701/70; 477/173

(57) ABSTRACT

A fuel injecting control method during coasting of a vehicle, may include operating coasting mode when a coasting mode operation condition is satisfied, maintaining the coasting mode for a predetermined interval, injecting fuel according to engine speed, cutting fuel injecting when detected vehicle speed is equal to or more than a predetermined fuel cutting vehicle speed and less than a predetermined vehicle over speed, operating an assist brake when the detected vehicle speed is equal to or more than the predetermined vehicle over speed, and releasing the coasting mode when a releasing condition of the coasting mode is satisfied.

### CROSS-REFERENCE TO RELATED APPLICATION

The present application claims priority to Korean Patent Application No 10-2009-0116097 filed in the Korean Intellectual Property Office on Nov. 27, 2009, the entire contents of which is incorporated herein for all purposes by this reference.

### BACKGROUND OF THE INVENTION

1. Field of the Invention

The present invention relates to a fuel injection control method. More particularly, the present invention relates to a fuel injecting control method during coasting of a vehicle that minimizes fuel injecting amount.

2. Description of Related Art

Generally, when a vehicle runs on a downhill road, a driver does not push an accelerator petal, and the vehicle keeps its speed, a control to cut fuel injection for reducing fuel consumption is operated.

However, in this control, driver's own intention is not sufficiently included and fuel cutting interval according to driving conditions is not long enough.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a fuel injecting control method during coasting of a vehicle having advantages of minimizing fuel injecting amount with a switch that reflects driver's intention and enlarging fuel cutting interval.

In an aspect of the present invention, the fuel injecting control method during coasting of a vehicle, may include operating coasting mode when a coasting mode operation condition is satisfied, maintaining the coasting mode for a predetermined interval, injecting fuel according to engine speed, cutting fuel injecting when detected vehicle speed is equal to or more than a predetermined fuel cutting vehicle speed and less than a predetermined vehicle over speed, operating an assist brake when the detected vehicle speed is equal to or more than the predetermined vehicle over speed, and releasing the coasting mode when a releasing condition of the coasting mode is satisfied.

The coasting mode operation condition is determined to exist: when the vehicle runs on a downhill road, when a coasting mode switch is ON, when a vehicle gear is deriving mode, when a vehicle speed sensor is not out of order, when a brake or the assist brake is not operated, when the detected vehicle speed is between a predetermined coasting mode minimum speed and a predetermined coasting mode maximum speed, when the engine speed is more than a predetermined coasting mode engine speed, and when detected accelerator pedal sensor amount is less than a predetermined coasting mode accelerator pedal sensor amount.

The coasting mode switch may be operated in communication with a retarder multi function switch.

The injecting fuel may be realized according to a map table that injecting fuel amount according to the engine speed is stored.

The assist brake may include a jake brake, an exhaust brake and a retarder.

The method may further include re-injecting fuel after the injecting fuel, wherein the re-injecting fuel is realized when the detected vehicle speed is less than a predetermined re-injecting vehicle speed limit.

The predetermined re-injecting vehicle speed limit may be less than the predetermined fuel cutting vehicle speed.

The releasing condition of the coasting mode may be determined to exist: when an engine is idle, when PTO (power take-off) states, when the vehicle is in cruise, when a coasting mode switch is OFF, when the vehicle runs on an uphill road, or when detected accelerator pedal sensor amount is more than a predetermined coasting mode releasing accelerator pedal sensor amount.

The releasing condition of the coasting mode may be determined to exist: when a brake is operated, when a clutch is operated or in neutral range, when the detected vehicle speed is more than a predetermined coasting mode releasing vehicle speed, or when the engine speed is more than a predetermined coasting mode releasing engine speed.

The releasing condition of the coasting mode may be determined to exist: when a retarder torque is more than a predetermined coasting mode releasing torque, or when a vehicle speed sensor is out of order.

According to the exemplary embodiment of the present invention, driver's intention may be reflected to the control method for providing the driver convenience and fuel cutting interval may be enlarged to reduce fuel consumption.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of a system realizing a fuel injecting control method during coasting of a vehicle according to an exemplary embodiment of the present invention.

FIG. 2 is a flow chart showing a fuel injecting control method during coasting of a vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

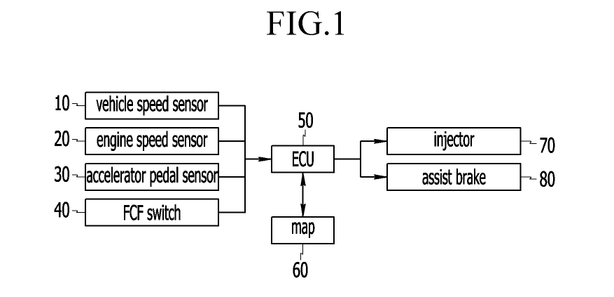

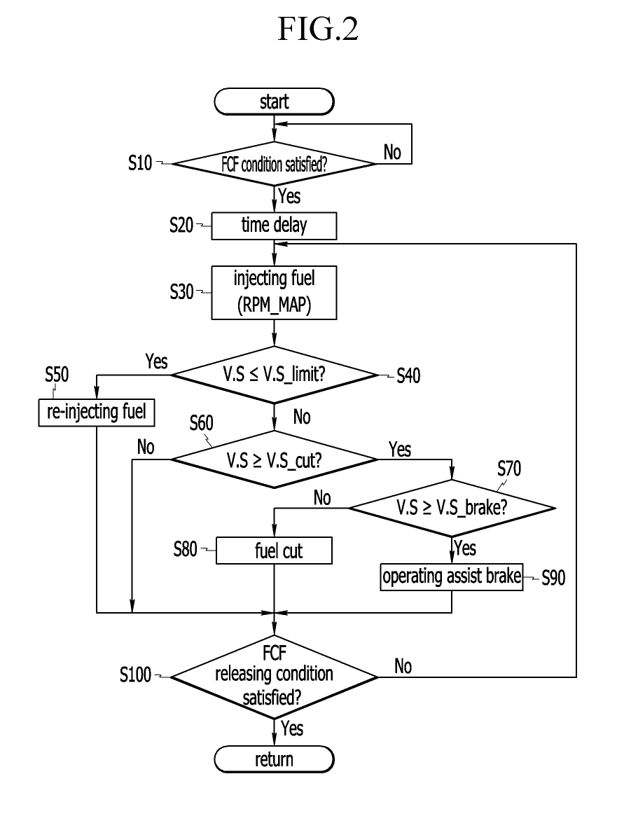

FIG. 1 is a schematic diagram of a system realizing a fuel injecting control method during coasting of a vehicle according to an exemplary embodiment of the present invention and FIG. 2 is a flow chart showing a fuel injecting control method during coasting of a vehicle according to an exemplary embodiment of the present invention.

A fuel injecting control system during coasting of a vehicle according to an exemplary embodiment of the present invention includes a vehicle speed sensor 10, an engine speed sensor 20, an accelerator pedal sensor 30, a FCF (fuel cut free) switch 40, an ECU (electric control unit) 50 that receives each signals from the vehicle speed sensor 10, the engine speed sensor 20, the accelerator pedal sensor 30 and the FCF (fuel cut free) switch 40 and controls operations of an injector 70 and an assist brake 80, and a map table 60. And injecting fuel amounts according to engine speed and so on are stored in the map table 60.

Referring to FIG. 2, a fuel injecting control method during coasting of a vehicle according to an exemplary embodiment of the present invention includes operating coasting mode when a coasting mode operation condition is satisfied (S10)—that is, determining FCF (fuel cut free) condition is satisfied and operating the coasting mode (S10), maintaining the coasting mode (S20), injecting fuel according to engine speed (S30), cutting fuel injecting when detected vehicle speed V.S is more than a predetermined fuel cutting vehicle speed V.S_cut (S60, S70 and S80), operating an assist brake when the detected vehicle speed V.S is more than a predetermined vehicle over speed V.S_brake (S60, S70 and S90), and releasing the coasting mode when a releasing condition of the coasting mode is satisfied (S100).

The coasting mode operation condition (S10) is determined to exist when a vehicle runs on a downhill road, when a coasting mode switch is ON, when a vehicle gear is deriving mode, when a vehicle speed sensor 10 is not out of order, when a brake (not shown) or the assist brake 80 is not operated, when detected vehicle speed V.S is between a predetermined coasting mode minimum speed and a predetermined coasting mode maximum speed, when engine speed is more than a predetermined coasting mode engine speed and when detected accelerator pedal sensor amount is less than a predetermined coasting mode accelerator pedal sensor amount. The predetermined coasting mode minimum speed, the predetermined coasting mode maximum speed, the coasting mode engine speed and the predetermined coasting mode accelerator pedal sensor amount can be arbitrarily set by a person of an ordinary skill in the art considering safety coasting of a vehicle.

The coasting mode switch mode switch 40 (FCF switch) can be provided in a passenger compartment or operates in response to (in communication with) a retarder multi function switch and can be realized as an enable switch.

For example, when a vehicle is provided with a retarder (one of assist brakes) and a retarder switch is shifted to 1st range, it can be determined that driver's intention is to drive a vehicle with coasting mode.

In the step S30, the injecting fuel amount can be determined according to the map table 60 that injecting fuel amount according to engine speed is stored which can be confirmed by experiments.

The assist brake 80 includes a jake brake, an exhaust brake and a retarder. When vehicle speed is over a predetermined speed, the assist brake 80 is operated to prevent from overspeeding situation while a vehicle runs on a downhill road.

The fuel injecting control method may further include re-injecting fuel after the injecting fuel S50.

The re-injecting fuel S50 is realized when detected vehicle speed V.S is less than a predetermined re-injecting vehicle speed limit V.S_limit (S40).

The predetermined re-injecting vehicle speed limit V.S_limit can be defined of a minimum vehicle speed that requires re-injection, and the re-injection of the step S 60 can elongate coasting of the vehicle.

The releasing condition of the coasting mode (S100) is determined to exist when the engine is idle, when PTO (power take-off) states, when the vehicle is in cruise, when the coasting mode switch 40 is OFF, when the vehicle runs on an uphill road or when detected accelerator pedal sensor 30 amount is more than a predetermined coasting mode releasing accelerator pedal sensor amount.

The releasing condition of the coasting mode (S100) is further determined to exist when the brake is operated, when a clutch is operated or in neutral range, when a detected vehicle speed is more than a predetermined coasting mode releasing vehicle speed or when a engine speed is more than a predetermined coasting mode releasing engine speed.

The releasing condition of the coasting mode (S100) is further determined to exist when a retarder torque is more than a predetermined coasting mode releasing torque or when a vehicle speed sensor is out of order.

The predetermined coasting mode releasing accelerator pedal sensor amount, the predetermined coasting mode releasing vehicle speed, the predetermined coasting mode releasing engine speed can be arbitrarily set by a person of an ordinary skill in the art considering safety coasting of a vehicle.

If the coasting mode operation conditions are satisfied, fuel injecting stops and the vehicle is coasting (S10).

In the maintaining the coasting mode of the step S20, injecting fuel stops for an predetermined interval to reduce fuel consumption and the predetermined interval can be arbitrarily set by a person of an ordinary skill in the art considering the designer's intention, convenience of control, weight of a vehicle, brake's operation timing and distance and so on.

And then fuel is injected according to engine speed (S30) and fuel supply amount is determined from the map table 60. The fuel supply amount can be confirmed by experiments for maintaining coasting of the vehicle in minimum amount to minimize fuel consumption and speed variation.

And then, comparing detected vehicle speed V.S is less than the predetermined re-injecting vehicle speed limit V.S_limit and if the detected vehicle speed V.S is less than the predetermined re-injecting vehicle speed limit V.S_limit (S40), fuel is re-injected (S50). The step S50 of the re-injecting fuel can maintain coasting of the vehicle by re-injecting small quantity of fuel so that fuel consumption can be reduced comparing when releasing the coasting mode (S100) is realized without the step S50.

The quantity of the fuel re-injection can be confirmed by experiments.

When the vehicle speed V.S is not less than the predetermined re-injecting vehicle speed limit V.S_limit (S40), it is compared that the vehicle speed V.S is more than the predetermined fuel cutting vehicle speed V.S_cut (S60), and if it is determined that the vehicle speed V.S is not more than the predetermined fuel cutting vehicle speed V.S_cut (S60), then it is determined whether the releasing condition of the coasting mode is satisfied (S100).

When the vehicle speed V.S is more than the predetermined fuel cutting vehicle speed V.S_cut (S60), and the vehicle speed V.S is not more than the predetermined vehicle over speed V.S_brake (S70), then fuel injection is cut to reduce fuel consumption (S80).

When the vehicle speed V.S is more than the predetermined fuel cutting vehicle speed V.S_cut (S60), and the vehicle speed V.S is more than the predetermined vehicle over speed V.S_brake (S70), then the assist brake 80 is operated so that frequent operation of a foot brake can be reduced and thus durability of the foot brake can be elongated.

The predetermined fuel cutting vehicle speed V.S_cut and the predetermined vehicle over speed V.S_brake are defined respectively as a vehicle speed that can reduce fuel consumption and keep the vehicle speed within some range and a vehicle speed that requires to reduce vehicle speed for safety driving and the predetermined fuel cutting vehicle speed V.S_cut and the predetermined vehicle over speed V.S_brake can be arbitrarily set by a person of an ordinary skill in the art considering safety coasting of a vehicle.

And then, it is determined whether releasing condition of the coasting mode is satisfied (S100), the coasting of the vehicle can be maintained if it is determined that releasing condition of the coasting mode is not satisfied.

As described above, according to the fuel injecting control method during coasting of a vehicle of the exemplary embodiment of the present invention, intervals of coasting of a vehicle can be elongated, limited fuel injection can reduce fuel consumption, and safety driving can be expected by fuel cutting and operations of the assist brake according to vehicle speed.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fuel injecting control method during coasting of a vehicle, the method comprising:
operating coasting mode when a coasting mode operation condition is satisfied;
maintaining the coasting mode for a predetermined interval;
injecting fuel according to engine speed;
cutting fuel injecting when detected vehicle speed is equal to or more than a predetermined fuel cutting vehicle speed and less than a predetermined vehicle over speed;
operating an assist brake when the detected vehicle speed is equal to or more than the predetermined vehicle over speed; and
releasing the coasting mode when a releasing condition of the coasting mode is satisfied.

2. The fuel injecting control method of claim 1, wherein the coasting mode operation condition is determined to exist:
when the vehicle runs on a downhill road;
when a coasting mode switch is ON;
when a vehicle gear is deriving mode;
when a vehicle speed sensor is not out of order;
when a brake or the assist brake is not operated;
when the detected vehicle speed is between a predetermined coasting mode minimum speed and a predetermined coasting mode maximum speed;
when the engine speed is more than a predetermined coasting mode engine speed; and
when detected accelerator pedal sensor amount is less than a predetermined coasting mode accelerator pedal sensor amount.

3. The fuel injecting control method of claim 2, wherein the coasting mode switch is operated in communication with a retarder multi function switch.

4. The fuel injecting control method of claim 1, wherein the injecting fuel is realized according to a map table that injecting fuel amount according to the engine speed is stored.

5. The fuel injecting control method of claim 1, wherein the assist brake comprises a jake brake, an exhaust brake and a retarder.

6. The fuel injecting control method of claim 1, the method further comprises re-injecting fuel after the injecting fuel.

7. The fuel injecting control method of claim 6, wherein the re-injecting fuel is realized when the detected vehicle speed is less than a predetermined re-injecting vehicle speed limit.

8. The fuel injecting control method of claim 7, wherein the predetermined re-injecting vehicle speed limit is less than the predetermined fuel cutting vehicle speed.

9. The fuel injecting control method of claim 1, wherein the releasing condition of the coasting mode is determined to exist:
when an engine is idle;
when PTO (power take-off) states;
when the vehicle is in cruise;
when a coasting mode switch is OFF;
when the vehicle runs on an uphill road; or
when detected accelerator pedal sensor amount is more than a predetermined coasting mode releasing accelerator pedal sensor amount.

10. The fuel injecting control method of claim 9, wherein the releasing condition of the coasting mode is determined to exist:
when a brake is operated;
when a clutch is operated or in neutral range;
when the detected vehicle speed is more than a predetermined coasting mode releasing vehicle speed; or
when the engine speed is more than a predetermined coasting mode releasing engine speed.

11. The fuel injecting control method of claim 10, wherein the releasing condition of the coasting mode is determined to exist:
when a retarder torque is more than a predetermined coasting mode releasing torque; or
when a vehicle speed sensor is out of order.
